(19) United States
(12) Patent Application Publication
(10) Pub. No.: US 2006/0235809 A1
(43) Pub. Date: Oct. 19, 2006

(54) Digital caricature

(76) Inventor: John Pearson, Walnut Creek, CA (US)

Correspondence Address: AVERILL & VARN, 8244 PAINTER AVE., WHITTIER, CA, 90602, US

(21) Appl. No.: 11/109,073

(22) Filed: Apr. 18, 2005

(51) Int. Cl. G06F 17/00

(52) U.S. Cl. 705/500; 720/718

(57) ABSTRACT

A method for creating a digital caricature combining aspects of a tourist destination with a likeness of a face. Digital backgrounds are drawn embodying themes associated with a tourist destination and various digital bodies are drawn. The backgrounds and/or bodies may be animated. A caricature booth or the like is set up at the tourist destination and the backgrounds and bodies are displayed for selection by a customer. A face is drawn onto the selected body and the face and body are superimposed on the selected background to create a digital caricature. The digital caricature is copied to a CD or other digital media for the customer. An E-card may also be created to allow the customer to share the animated caricature over the Internet. A link to a web site for the vacation destination may be provided on the animation window and on the E-card for advertising.

### BACKGROUND OF THE INVENTION

The present invention relates to creating a digital caricature and in particular to creation of an animated digital caricature of a tourist at a tourist and/or vacation destination.

Many tourists, vacationers, and travelers in general enjoy obtaining memorabilia at tourist and/or vacation destinations such as amusement parks, theme parks, sports events, casinos, cruises, or any location away from home. Business travelers also often enjoy collecting memorabilia on their business trips. One very popular form of memorabilia is a caricature of the tourist, vacationer, or traveler drawn at a caricature booth or the like, which caricature combines memories of the vacation, event, or trip with a caricature (or likeness) of the tourist, vacationer, or traveler. Although such caricatures provide a memory of the vacation, event, or trip, it is limited in creativity and only exists as a single caricature artwork. There is a desire by tourists to share their experiences with others, and by vacation destinations to integrate advertising with memorabilia. Unfortunately, a single caricature artwork is not easily shared and adding advertising to a caricature artwork detracts from the appearance of the caricature.

### BRIEF SUMMARY OF THE INVENTION

The present invention addresses the above and other needs by providing a method for creating an animated digital caricature combining aspects of a travel destination with a likeness of a customer or with a likeness provided by a customer. A multiplicity of backgrounds are created embodying a number of themes associated with a location, trip, vacation, tourist destination, vacation destination, sports event, celebrity, or any theme a traveler may desire to associate with. Various bodies are drawn which may be superimposed onto the backgrounds. The backgrounds and/or the bodies may include digital animation. A caricature booth or the like is set up at a location frequented by tourists, vacationers, or travelers and the backgrounds and bodies are displayed and selected by a customer. The selected body is superimposed on the selected background. An artist digitally draws a digital likeness of a head or face onto the body. The resulting caricature is provided in a digital form to the customer and/or in a printed form. The digital caricature may be used as an E-card to allow the customer to share the digital caricature over the Internet. A link to a web site for the vacation destination may be provided on a caricature window and on the E-card for advertising.

In accordance with one aspect of the invention, there is provided a method for creation of a digital caricature. The method comprises drawing at least one digital background associated with a tourist destination or event, drawing at least one digital body, displaying the at least one digital background and the at least one digital body at a point of sale, selecting one of the at least one digital background and at least one of the at least one digital body, drawing a digital likeness of a face or head onto the selected at least one digital body to create the digital caricature, and providing a digital version of the digital caricature to a customer. The digital version may further include information regarding a tourist destination, and may include a link to a web site containing information regarding the tourist destination. Providing the digital version may be providing a Compact Disk (CD), uploading files to a web site and providing access information to the files, or any method of providing digital information.

In accordance with another aspect of the invention, there is provided a vacation memorabilia comprising a digital background associated with a tourist destination or event, a digital body superimposed on the digital background, and a digital caricature of a face superimposed on the digital body. The face is drawn and superimposed on the digital body at a point of sale. The digital caricature is stored on a digital media, and digital information or a link to information regarding the travel destination may be provided on the digital media.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a first frame including a digital background and a digital body.

FIG. 2 is a second frame including the digital background and the digital body.

FIG. 3 is the digital background and the digital body with a likeness of a face drawn onto the digital body.

FIG. 4 is a window of a digital animated caricature according to the present invention.

FIG. 5 is a method for creating the digital animated caricature according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

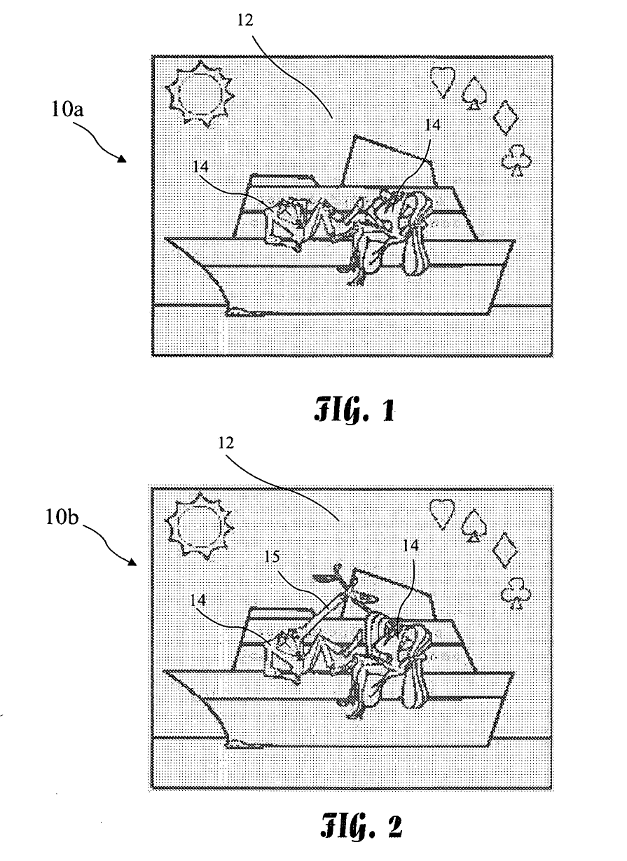

A first frame 10a including a digital background 12 and digital bodies 14 is shown in FIG. 1. The background 12 includes a cruise ship, ocean, sun, and symbols associated with a casino. Other backgrounds may include a likeness of some well known location, object, celebrity, or activity, or may include a likeness of a tourist destination such as a resort, a theme park, a major attraction (for example, the Statue of Liberty), a sports event (for example the World Series or the Super Bowl), a casino, a cruise ship, or any background associate with any tourist destination. The background 12 may also be an action background, for example riding a motorcycle, playing a sport, or the like.

The background 12 is preferably created from one or more of freehand drawing using a computer input device (e.g., a electronic pen tablet or a mouse), using digital drawing tools, by scanning a photograph, by loading a digital photograph, by hand drawing on paper and scanning the drawing into a computer, or from any other image source. The background 12 is more preferably created freehand using an electronic pen tablet in a Flash® software environment. An example of a suitable electronic pen tablet is the Cintiq 21 UX® tablet made by Wacom Technology in Vancouver, Wash. The body 14 is generally drawn separately from the background 12, and a customer may choose from a multiplicity of backgrounds and bodies to combine. The multiplicity of digital bodies may include men, women, children, various manner of dress, physical size, etc. The creation of the backgrounds 12 and bodies 14 generally require more effort and include more detail than the faces 16 (see FIG. 3), and the creation of digital backgrounds 12 and faces 14 in advance allows more time for their creation. The backgrounds 12, bodies 14, and faces 16 are preferable created using a motion graphics program to provide animation. The motion graphics program may be a manual frame generation program or a model based frame generation program.

A manual frame generation program allows an artist to manually create individual frames of an animation. The frame to frame change creating the animation is manually drawn by the artist. An example of a manual frame generation program is Flash® software from Macromedia in San Francisco, Calif. For example, using Flash® software an artist may create an animated digital body by drawing a single view of a torso on a first layer which remains unchanged, and several views of an arm on a second layer which show the arm in different positions. The Flash® software may be used to specify and display the combination of the torso with a selected order of views of the arm to create animation. A remaining third layer may be reserved for later drawing a face onto the body at a point of sale. An animated digital background may be created in the same manner as the animated digital body, i.e., by drawing a first layer which remains constant (for example, the hull of a cruise ship), and drawing at least two second layers (for example, showing waves crashing against the bow of the cruise ship) which are displayed in an order to create animation. Only one version of each layer is shown at a single time.

A model based frame generation program (or 3D model based frame generation program) is more sophisticated and may be used to create an animated 3D model of an object or character, and the model is manipulated to create frames producing an appearance of motion for the object or character. An example of a model based frame generation program is Maya™ software made by Alias in Toronto, Canada.

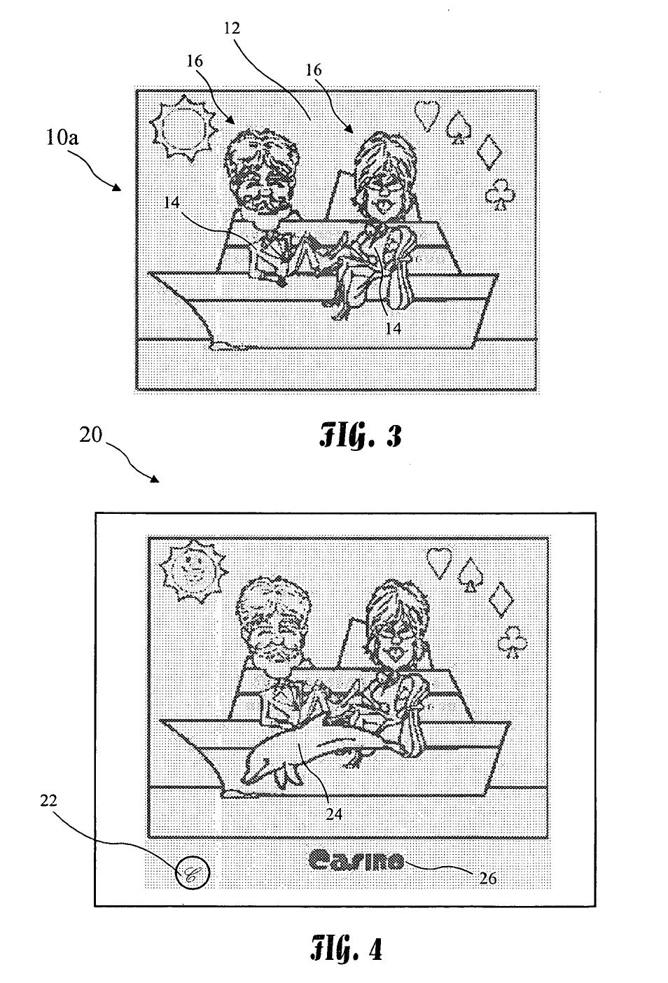

A second frame 10b of the electronically created caricature background 12 and bodies 14 is shown in FIG. 2. The second frame 10b includes a change which representing a motion of an arm 15 of the body 14. The motion could also be a motion of the background 12 (for example, an animal running by a bird flying, the sun, moon, or stars moving across the sky, or any other motion in the background). The sequential display of a number of frames (for example, by Flash® software) creates the animated digital caricature. More specifically, a second layer (in this example, the background 12 is a first layer) including all of the body 14 except the arms 15, remains unchanged from the view in FIG. 1 to the view in FIG. 2. A third layer including one arm 15 of each body 14, includes at least two drawings to provide animation. The animated caricature may further include interactivity, for example, by clicking a mouse in a particular portion of the image, to cause, for example, the arm 15 to wave or eyes to blink. Although the body 14 is generally a human body, the body 14 may also be an animal, for example a lion.

The electronically created caricature background 12 is shown in FIG. 3 with likenesses of faces (or heads) 16 added to the bodies 14. The faces 16 may be drawn using an electronic pen tablet in, for example, a Flash® software environment as described above for the background 12 and bodies 14. Two or more frames of the faces 16 may be drawn to provide animation of the faces 16, for example, blinking eyes or a smiling face. The animation may be triggered when a mouse is clicked on or near the faces 16, or may be periodically triggered. Using the Flash® software described above, the two or more faces may be drawn on a single layer, or a face without eyes may be drawn on one layer, and an additional layer may include two or more drawings of the eyes.

A window 20 containing the digital caricature is shown in FIG. 4. The window 20 is preferably an animated window generated by the Flash® software. Background animation, for example a jumping fish 24, may be included in the background 12 in the same manner as described for providing the moving arm 15 in FIG. 2. A name 26 or other identification may also be provided. The digital caricature may also include a sound track, which sound track may, or may not, be associated with the tourist destination. When a particular sound track is associated with a particular tourist destination, the particular sound track is preferably included. Further, the customer may record a message or description to include with the digital caricature for their own future enjoyment, and to include in an associated E-card. The customer sound track may be recorded at the caricature booth, or added later by the customer.

The window 18 may include a link 22 to information pertaining to the tourist destination, links to a web site for the tourist destination, links to a home page for the customer, to a web site pertaining to the caricature provider, or to any other software or web site. Preferably, the link is to advertising for the tourist destination. Files necessary to play the digital caricature 18 may be provided on a Compact Disk (CD), on a floppy disk, on a thumb drive, on electronic media provided by a customer, or posted to a web site. When the digital caricature 18 is posted to a web site, access information is provided to the customer. The digital caricature 18 may also be used an E-card, and may be stored on a web site or provided directly to the customer. A digital caricature may also be printed and provided to the customer.

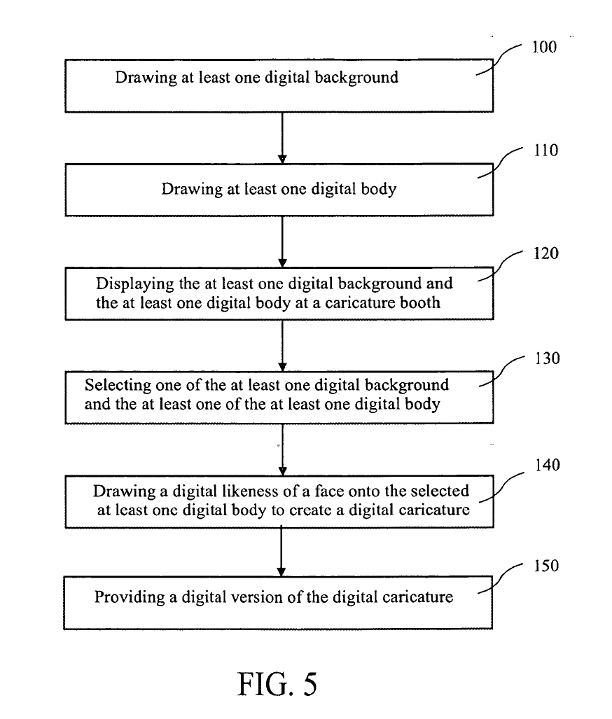

A method for creating the animated caricature according to the present invention is shown in FIG. 5. The method includes drawing at least one digital background associated with a tourist destination at step 100, drawing at least one digital body at step 110, displaying the at least one digital background and the at least one digital body at a point of sale at step 120, selecting one of the at least one digital background and at least one of the at least one digital body at step 130, drawing a digital likeness of a face onto the selected at least one digital body to create a digital caricature at step 140, and providing a digital version of the digital caricature at step 140. The step 100 of creating at least one digital background associated with tourist destination may comprise using any of the methods for drawing described in FIG. 1. A preferred tool for drawing the digital background and the digital body is an electronic pen tablet such as the Cintiq 21 UX® tablet. The background and the body may be animated, and the animated frames may be manually created as described in FIGS. 1 and 2 using manual frame generation tool such as Flash® software, or using a model based generation tool such as Maya® software.

The step 120 of displaying the at least one digital background and the at least one digital body at a point of sale may comprise displaying the at least one digital background and the at least one digital body at a caricature booth and/or may comprise displaying a printout of the at least one digital background and the at least one digital body at the caricature booth. The backgrounds and bodies may be displayed separately and/or may be displayed with the body superimposed on the background. When the backgrounds and bodies are displayed separately, a sample including a head and/or face may be provided to give a customer a better idea of the appearance of the completed caricature. The step 140 of drawing a digital likeness of a face preferably comprises an artist working in the caricature booth drawing a face and/or head into a digital body (which body may be superimposed on a background) using a mouse or an electronic pen tablet (e.g., a Wacom tablet), and more preferably using an electronic pen tablet. The face may further include at least one layer including two or more frames to provide an animated face. Electronically drawing a likeness may further comprise drawing two or more likenesses, for example, likenesses of a couple or of a family. The likeness may be of the customer, or may be taken from a photo or other likeness of another person. The likeness may also be taken from an Internet site specified by the customer.

The step 150 of providing a digital version of the electronic caricature may comprise providing a CD, floppy disk, thumb, drive, or any other form of electronic media to a customer. The digital version may also be provided by posting on a web site and providing access information to the customer. The digital version may include an E-card and a window generated by the digital version may further include a link to information or advertising for a tourist destination as described in FIG. 4.

When animation is created using Flash® software, the viewable animation (or final film) is created by publishing the film (or window). The film can be published in still image formats like a Joint Photographic Experts Group (JPEG) file, a Graphical Interchange File Format (GIFF) file, or a Portable Network Graphics (PNG) file. The film can be published in animated format such as Shockwave Files (SWFs) files, Executable (EXEs) files, or Hyper Text Markup Language (HTML) files. Each file type has a purpose and function. The customers may be given a JPEG file, an EXE file, an SWF file, and/or an HTML file. JPEG files provide a still image suitable for a screen saver or for printed, EXE files are easily opened on any computer, the HTML's are better for Macintosh® computers, and the SWF files are good for posting on the Internet.

While the invention herein disclosed has been described by means of specific embodiments and applications thereof, numerous modifications and variations could be made thereto by those skilled in the art without departing from the scope of the invention set forth in the claims.

I claim:

1. A method for creating a digital caricature, the method comprising:
creating at least one digital background;
creating at least one digital body;
displaying the at least one digital background and at least one digital body at a point of sale;
selecting one of the at least one digital background;
selecting at least one of the at least one body;
digitally drawing a likeness of a face onto the digital body to create the digital caricature; and
providing the digital caricature to a customer.

2. The method of claim 1, wherein creating at least one digital background comprises creating at least one digital background associated with a tourist destination.

3. The method of claim 2, wherein creating at least one digital background comprises creating at least one digital background embodying a recognized feature of the tourist destination.

4. The method of claim 3, wherein creating at least one digital background embodying a recognized feature of the tourist destination comprises creating at least one digital background embodying a recognized feature of at least one tourist destination selected from a group consisting of a theme park, a sports event, a casino, and a cruise ship.

5. The method of claim 4, wherein creating at least one digital background embodying a recognized feature of the tourist destination comprises creating a animated digital background embodying themes from a theme park.

6. The method of claim 1, wherein creating at least one digital body comprises creating at least one animated digital body.

7. The method of claim 1, wherein creating at least one digital background and creating at least one digital body comprises creating at least one of at least one animated digital background and at least one animated digital body using a motion graphics program.

8. The method of claim 7, wherein creating at least one of at least one animated digital background and at least one animated digital body using a motion graphics program comprises creating at least one of the at least one animated digital background and the at least one animated digital body using manual frame generation.

9. The method of claim 7, wherein creating at least one of at least one animated digital background and at least one animated digital body using a motion graphics program comprises creating at least one of the at least one animated digital background and the at least one animated digital body using model based frame generation.

10. The method of claim 1, wherein creating at least one digital background comprises drawing at least one digital background using an electronic pen tablet.

11. The method of claim 1, wherein digitally drawing a likeness of a face comprises digitally drawing a likeness of a face of a tourist.

12. The method of claim 1, wherein providing the digital caricature to the customer comprises:
copying the digital caricature to a Compact Disk (CD); and
providing the CD to the customer.

13. The method of claim 1, wherein providing the digital caricature to the customer comprises uploading the digital caricature to a web site and providing access information to the customer to allow access to the digital caricature on the web site.

14. The method of claim 1, wherein providing the digital caricature to the customer includes providing the digital caricature including at least one E-card.

15. The method of claim 14, wherein providing the digital caricature including at least one E-card includes providing the at least one E-card with at least one link to at least one web site for a tourist destination.

16. A method for creating a digital caricature, the method comprising:
drawing at least one digital background associated with a tourist destination;
drawing at least one digital body;
displaying the at least one digital background and the at least one digital body at a caricature booth;
selecting one of the at least one digital background and at least one of the at least one digital body;
drawing a digital likeness of a face onto the selected at least one digital body to create the digital caricature; and
providing a digital version of the digital caricature to a customer.

17. The method of claim 16, wherein drawing at least one digital background comprises drawing at least one animated digital background.

18. The method of claim 16, wherein drawing at least one digital body comprises drawing at least one animated digital body.

19. A memorabilia comprising:
a digital background selected from a multiplicity of backgrounds associated with a tourist destination;
a digital body selected from a multiplicity of bodies, the digital body superimposed on the digital background;
a digital caricature of a face superimposed on the digital body, wherein the face is drawn and superimposed on the digital body at a point of sale;
a digital media for storing the digital caricature; and
at least one of digital information regarding the tourist destination and a link to digital information regarding the tourist destination stored on the digital media.

20. The method of claim 19, wherein the digital caricature is an animated digital caricature.
